(19) United States
(12) Patent Application Publication
(10) Pub. No.: US 2025/0273680 A1
(43) Pub. Date: Aug. 28, 2025

(54) NEGATIVE ELECTRODE FOR SECONDARY BATTERY, AND SECONDARY BATTERY

(71) Applicant: MURATA MANUFACTURING CO., LTD., Kyoto (JP)

(72) Inventors: Yosuke KOIKE, Kyoto (JP); Naoki HAYASHI, Kyoto (JP)

(21) Appl. No.: 19/208,192

(22) Filed: May 14, 2025

Related U.S. Application Data
(63) Continuation of application No. PCT/JP2023/042185, filed on Nov. 24, 2023.

(30) Foreign Application Priority Data
Jan. 27, 2023 (JP) 2023-010913

(51) Int. Cl. H01M 4/587; H01M 4/36; H01M 4/48; H01M 4/62; H01M 10/0525

(52) U.S. Cl. CPC H01M 4/587; H01M 4/366; H01M 4/48; H01M 4/623; H01M 4/625; H01M 10/0525

(57) ABSTRACT

A secondary battery includes a positive electrode, a negative electrode, and an electrolytic solution. The negative electrode includes a carbon-containing layer, and a negative electrode active material layer provided on the carbon-containing layer. The negative electrode active material layer includes a negative electrode active material including a silicon-containing material, and a negative electrode binder including a N-vinylacetamide polymer.

### CROSS REFERENCE TO RELATED APPLICATIONS

The present application is a continuation of International Application No. PCT/JP2023/042185, filed on Nov. 24, 2023, which claims priority to Japanese Patent Application No. 2023-010913, filed on Jan. 27, 2023, the entire contents of which are incorporated herein by reference.

### BACKGROUND

The present technology relates to a negative electrode for a secondary battery, and to a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode (a negative electrode for a secondary battery), and an electrolytic solution. A configuration of the secondary battery has been considered in various ways.

Specifically, a negative electrode includes a negative electrode active material (Si), a negative electrode binder (an aqueous polyimide-based material), and an aqueous thickener (poly-N-vinylacetamide), and a content of the negative electrode binder and a content of the aqueous thickener are specified. A negative electrode includes negative electrode active materials (Si and a carbon material) and a negative electrode binder (poly-N-vinylacetamide), and a physical property of the negative electrode binder and a peel strength of the negative electrode are specified.

### SUMMARY

The present technology relates to a negative electrode for a secondary battery, and to a secondary battery.

Although consideration has been given in various ways regarding a configuration of a secondary battery, a battery characteristic of the secondary battery is not sufficient yet. Accordingly, there is room for improvement in terms of the battery characteristic of the secondary battery.

It is desirable to provide a negative electrode for a secondary battery, and a secondary battery each of which makes it possible to achieve a superior battery characteristic.

A negative electrode for a secondary battery according to an embodiment of the present technology includes a carbon-containing layer, and a negative electrode active material layer provided on the carbon-containing layer. The negative electrode active material layer includes a negative electrode active material including a silicon-containing material, and a negative electrode binder including an N-vinylacetamide polymer.

A secondary battery according to an embodiment of the present technology includes a positive electrode, a negative electrode, and an electrolytic solution. The negative electrode has a configuration similar to the configuration of the negative electrode for the secondary battery according to an embodiment of the present technology described above.

Here, the “carbon-containing layer” is a layer including a carbon material, and the “silicon-containing material” is a material including silicon as a constituent element. The “N-vinylacetamide polymer” includes a homopolymer of N-vinylacetamide, a copolymer of N-vinylacetamide, or both. Note that each of the carbon material, the silicon-containing material, and the N-vinylacetamide polymer will be described in detail later.

According to the negative electrode for the secondary battery of an embodiment of the present technology or the secondary battery of an embodiment of the present technology: the negative electrode for the secondary battery includes the carbon-containing layer and the negative electrode active material layer; the negative electrode active material layer includes the negative electrode active material and the negative electrode binder; the negative electrode active material includes the silicon-containing material; and the negative electrode binder includes the N-vinylacetamide polymer. Accordingly, it is possible to achieve a superior battery characteristic.

Note that effects of the present technology are not necessarily limited to those described herein and may include any of a series of effects in relation to the present technology.

### BRIEF DESCRIPTION OF THE FIGURES

FIG. 1 is a sectional diagram illustrating a configuration of a negative electrode for a secondary battery according to an embodiment of the present technology.

FIG. 2 is a sectional diagram illustrating a configuration of a negative electrode for a secondary battery according to an embodiment of the present technology.

FIG. 3 is a perspective diagram illustrating a configuration of a secondary battery according to an embodiment of the present technology.

FIG. 4 is a sectional diagram illustrating, in an enlarged manner, a configuration of a battery device illustrated in FIG. 3.

FIG. 5 is another sectional diagram illustrating, in an enlarged manner, the configuration of the battery device illustrated in FIG. 4.

FIG. 6 is a sectional diagram illustrating a configuration of a negative electrode for a secondary battery according to Modification example 1.

FIG. 7 is a block diagram illustrating a configuration of an application example of the secondary battery.

### DETAILED DESCRIPTION

The present technology is described below in further detail including with reference to the drawings according to an embodiment.

A description is given first of a negative electrode for a secondary battery according to a first embodiment of the present technology. The negative electrode for the secondary battery will hereinafter be simply referred to as the “negative electrode”.

The negative electrode to be described here is to be used in a secondary battery, which is an electrochemical device. However, the negative electrode may be used in electrochemical devices other than a secondary battery. Specific examples of the other electrochemical devices include a primary battery and a capacitor.

An electrode reactant is to be inserted into and extracted from the negative electrode upon an electrode reaction. The electrode reactant is not particularly limited in kind, and is specifically a light metal such as an alkali metal or an alkaline earth metal. Specific examples of the alkali metal include lithium, sodium, and potassium. Specific examples of the alkaline earth metal include magnesium and calcium.

Examples are given below of a case where the electrode reactant is lithium. Lithium is inserted into and extracted from the negative electrode in an ionic state upon the electrode reaction.

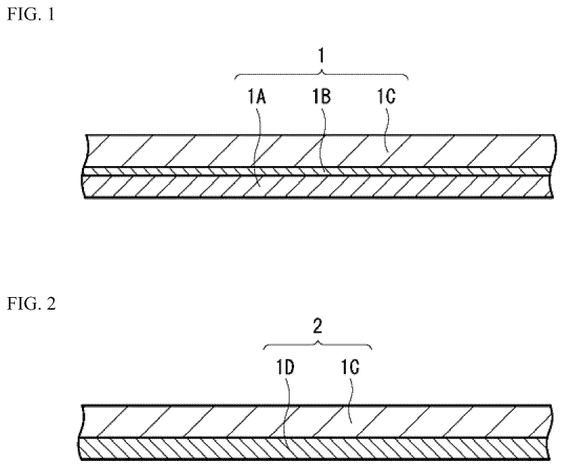

FIG. 1 illustrates a sectional configuration of a negative electrode 1 that is an example of the negative electrode of the first embodiment. As illustrated in FIG. 1, the negative electrode 1 includes a negative electrode current collector 1A, a base layer 1B, and a negative electrode active material layer 1C.

The negative electrode current collector 1A has two opposed surfaces on each of which the base layer 1B and the negative electrode active material layer 1C are to be provided. The negative electrode current collector 1A includes a metal material. Specific examples of the metal material include copper.

A surface of the negative electrode current collector 1A is preferably roughened. One reason for this is that this improves adherence of each of the base layer 1B and the negative electrode active material layer 1C to the negative electrode current collector 1A owing to what is called an anchor effect. A roughening method is not particularly limited, and may be, for example, a method in which microparticles are formed on a surface of a metal foil through an electrolytic treatment. In the electrolytic treatment, the microparticles are formed on the surface of the metal foil by an electrolytic method in an electrolyzer. This provides the surface of the metal foil with asperities.

The base layer 1B is a carbon-containing layer of the first embodiment.

The base layer 1B is provided on the negative electrode current collector 1A. The base layer 1B is therefore interposed between the negative electrode current collector 1A and the negative electrode active material layer 1C. A thickness of the base layer 1B is not particularly limited, and may be set as desired.

Here, the base layer 1B is provided on one of the two opposed surfaces of the negative electrode current collector 1A. Note, however, that the base layer 1B may be provided on each of the two opposed surfaces of the negative electrode current collector 1A.

The base layer 1B is the carbon-containing layer as described above, and therefore includes any one or more of carbon materials. The carbon materials are not particularly limited in kind, and specific examples thereof include graphitizable carbon, non-graphitizable carbon, and graphite (natural graphite and artificial graphite).

A method of forming the base layer 1B is not particularly limited, and specifically includes any one or more of methods including, without limitation, a coating method, a vapor-phase method, and a liquid-phase method. Specific examples of the vapor-phase method include a sputtering method and a chemical vapor deposition (CVD) method.

Reasons why the base layer 1B that is the carbon-containing layer is interposed between the negative electrode current collector 1A and the negative electrode active material layer 1C are as described below.

A first reason is that an interface resistance at an interface between the negative electrode current collector 1A and the negative electrode active material layer 1C decreases. Accordingly, electrical conductivity (electron conductivity) between the negative electrode current collector 1A and the negative electrode active material layer 1C improves. As a result, electrical conductivity of the negative electrode 1 improves.

A second reason is that adherence of the negative electrode active material layer 1C to the negative electrode current collector 1A improves. Accordingly, the negative electrode active material layer 1C is prevented from being easily detached from the negative electrode current collector 1A even if the negative electrode active material layer 1C includes a large amount of a silicon-containing material that easily expands and contracts upon the electrode reaction.

Note that the base layer 1B may further include any one or more of other materials.

When the coating method is to be adopted as the method of forming the base layer 1B, specific examples of the other materials include a binder. The binder included in the base layer 1B will hereinafter be referred to as a “base binder” to be distinguished from a binder included in the negative electrode active material layer 1C, i.e., a negative electrode binder, to be described later. The base binder is the binder included in the base layer 1B that is a single-layer-containing layer, and is therefore what is called a carbon binder.

The base binder includes any one or more of a synthetic rubber or a polymer compound. Specific examples of the synthetic rubbers include a styrene-butadiene-based rubber, a fluorine-based rubber, and ethylene propylene diene. Specific examples of the polymer compounds include polyvinylidene difluoride, polyimide, carboxymethyl cellulose, and an N-vinylacetamide polymer. The N-vinylacetamide polymer will be described in detail later.

It is preferable that the base binder include the N-vinylacetamide polymer, in particular. One reason for this is that, because, as will be described later, the negative electrode binder included in the negative electrode active material layer 1C includes the N-vinylacetamide polymer, the base binder and the negative electrode binder are of mutually common kinds. Accordingly, adherence between the base binder and the negative electrode binder improves. As a result, adherence between the base layer 1B and the negative electrode active material layer 1C improves.

The method of forming the base layer 1B including the carbon material and the base binder is not particularly limited, and specific examples thereof include the coating method, as described above. The base layer 1B formed by the coating method is what is called a primer coat layer.

The negative electrode active material layer 1C is provided on the base layer 1B, and includes a negative electrode active material and the negative electrode binder. Accordingly, the negative electrode active material layer 1C is electrically coupled to the negative electrode current collector 1A via the base layer 1B.

Here, the negative electrode active material layer 1C is provided on one of the two opposed surfaces of the negative electrode current collector 1A. Note, however, that the negative electrode active material layer 1C may be provided on each of the two opposed surfaces of the negative electrode current collector 1A.

A method of forming the negative electrode active material layer 1C is not particularly limited, and specifically includes any one or more of methods including, without limitation, the coating method, the vapor-phase method, the liquid-phase method, a thermal spraying method, and a firing (sintering) method.

The negative electrode active material is a material into which lithium is to be inserted and from which lithium is to be extracted, and includes any one or more of silicon-containing materials. One reason for this is that silicon has superior lithium insertability, thus allowing for a high energy density.

The “silicon-containing material” is a material including silicon as a constituent material. That is, the silicon-containing material may be a simple substance of silicon, a silicon alloy, a silicon compound, a mixture of two or more thereof, or a material including two or more phases thereof. The silicon-containing material is not particularly limited in state, but may specifically be a solid solution, a eutectic (a eutectic mixture), an intermetallic compound, or in a state including two or more thereof that coexist.

Note that the simple substance of silicon merely refers to a simple substance in a general sense. The simple substance may therefore include a small amount of impurity. That is, purity of the simple substance of silicon does not necessarily have to be 100%.

The silicon alloy is not particularly limited. Specifically, the silicon alloy includes any one or more of metal elements including, without limitation, tin, nickel, copper, iron, cobalt, manganese, zinc, indium, silver, titanium, germanium, bismuth, antimony, and chromium as one or more constituent elements other than silicon.

The silicon alloy includes not only a material including one or more metal elements as one or more constituent elements, but may also include a material including one or more metal elements and one or more metalloid elements as constituent elements. Note that the silicon alloy may further include one or more non-metallic elements as one or more constituent elements.

The silicon compound is not particularly limited in kind. Specifically, the silicon compound includes any one or more of non-metallic elements including, without limitation, oxygen and carbon as one or more constituent elements other than silicon. Note, however, that the silicon compound may include, as one or more constituent elements, any one or more of the series of metal elements included as constituent elements in the silicon alloy.

Specific examples of the silicon alloy and the silicon compound include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOₓ (where 0<x≤2 or 0.2 <x<1.4), and LiSiO. Note, however, compositions of the specific examples of the silicon alloy and the silicon compound are not limited to the compositions described here, and may be changed as desired.

Note that the negative electrode active material may further include any one or more of carbon materials. That is, the negative electrode active material may include both the silicon-containing material and the carbon material. One reason for this is that in the secondary battery including the negative electrode 1, damage to the negative electrode active material layer 1C is suppressed while a battery capacity is secured.

In more detail, while the silicon-containing material has an advantage of having a high theoretical capacity, there is a concern that the silicon-containing material easily expands and contracts greatly upon charging and discharging. In contrast, while there is a concern that the carbon material has a low theoretical capacity, the carbon material has an advantage of not easily expanding and contracting upon charging and discharging. Thus, the combined use of the carbon material and the silicon-containing material suppresses expansion and contraction of the negative electrode active material layer 1C upon charging and discharging while achieving a high theoretical capacity. This suppresses the damage to the negative electrode active material layer 1C while the battery capacity is secured, as described above.

Specific examples of the carbon material include graphitizable carbon, non-graphitizable carbon, and graphite (natural graphite and artificial graphite).

A mixture ratio between the silicon-containing material and the carbon material is not particularly limited, and may be set as desired. In particular, a proportion of a weight of the silicon-containing material to a sum of the weight of the silicon-containing material and a weight of the carbon material is preferably 30 wt % or greater. One reason for this is that the damage to the negative electrode active material layer 1C is sufficiently suppressed while a sufficient battery capacity is obtainable. The proportion is calculated based on the following calculation expression: proportion (wt %)=[weight of silicon-containing material/(weight of silicon-containing material+weight of carbon material)]×100.

The negative electrode binder is a material that bonds the negative electrode active materials to each other, and includes any one or more of N-vinylacetamide polymers.

One reason why the negative electrode binder includes the N-vinylacetamide polymer is that this improves physical strength of the negative electrode active material layer 1C. Thus, even upon repeated electrode reactions, the negative electrode active material layer 1C is easily maintained without being damaged, and the negative electrode active material layer 1C is prevented from being easily detached from the negative electrode current collector 1A. This improves physical durability of the negative electrode 1. In this case, cracking of the negative electrode active material layer 1C is prevented, and detachment of the negative electrode active material layer 1C from the negative electrode current collector 1A is also prevented.

Note that the negative electrode binder may further include either polyvinylidene difluoride or a styrene butadiene rubber. That is, the negative electrode binder may include both the N-vinylacetamide polymer and the polyvinylidene difluoride, or may include both the N-vinylacetamide polymer and the styrene butadiene rubber. One reason for this is that this further improves the physical strength of the negative electrode active material layer 1C, thus further preventing the negative electrode active material layer 1C from being easily damaged even upon repeated electrode reactions.

The “N-vinylacetamide polymer” includes a homopolymer of N-vinylacetamide, a copolymer of N-vinylacetamide, or both, as described above. The homopolymer of N-vinylacetamide is what is called poly-N-vinylacetamide.

The copolymer of N-vinylacetamide is a compound in which N-vinylacetamide and one or more monomers (excluding N-vinylacetamide) are copolymerized. The monomers are not particularly limited in kind, and specific examples thereof include an acrylic acid, a methacrylic acid, an acrylic acid alkali metal salt, an acrylic acid alkaline earth metal salt, a methacrylic acid alkali metal salt, and a methacrylic acid alkaline earth metal salt.

Specific examples of the acrylic acid alkali metal salt include lithium acrylate, sodium acrylate, and potassium acrylate. Specific examples of the acrylic acid alkaline earth metal salt include calcium acrylate and magnesium acrylate. Specific examples of the methacrylic acid alkali metal salt include lithium methacrylate, sodium methacrylate, and potassium methacrylate. Specific examples of the methacrylic acid alkaline earth metal salt include calcium methacrylate and magnesium methacrylate.

A copolymerization amount of the monomer(s) in the copolymer of N-vinylacetamide is not particularly limited, and may be set as desired.

Note that the negative electrode active material layer 1C may further include any one or more of other materials.

Specific examples of the other materials include other negative electrode active materials. The other negative electrode active materials each include any one or more of metal-based materials. Note that the silicon-containing material described above is excluded from the metal-based materials described here.

The metal-based materials are each a material that includes, as one or more constituent elements, any one or more elements among metal elements and metalloid elements that are each able to form an alloy with lithium. Specific examples of the metal elements and the metalloid elements include tin. The metal-based materials may each be a simple substance, an alloy, a compound, a mixture of two or more thereof, or a material including one or more phases thereof.

Further, the specific examples of the other materials include other negative electrode binders, and the other negative electrode binders each include any one or more of a synthetic rubber or a polymer compound. Note that the N-vinylacetamide polymer, polyvinylidene difluoride, and the styrene butadiene rubber that have been described above are excluded from the other negative electrode binders described here. Specific examples of the synthetic rubber include a fluorine-based rubber, and ethylene propylene diene. Specific examples of the polymer compound include polyimide and carboxymethyl cellulose.

Further, the specific examples of the other materials include a negative electrode conductor. The negative electrode conductor includes any one or more of a carbon material, a metal material, or an electrically conductive polymer compound. The carbon material may include a fibrous carbon material, a particulate carbon material, or both. Specific examples of the fibrous carbon material include carbon fibers, carbon nanofibers, and carbon nanotubes. Specific examples of the particulate carbon material include graphite, carbon black, acetylene black, and Ketjen black.

In the negative electrode 1, upon the electrode reaction, lithium is inserted into the negative electrode active material included in the negative electrode active material layer 1C, and lithium is extracted from the negative electrode active material. In this case, lithium is inserted and extracted in an ionic state.

The negative electrode 1 is manufactured by the following example procedure.

First, the carbon material and the base binder are mixed with each other to thereby obtain a base mixture. Thereafter, the base mixture is put into a solvent to thereby prepare a base mixture slurry in paste form. The solvent may be an aqueous solvent, or may be an organic solvent. Thereafter, the base mixture slurry is applied on one of the two opposed surfaces of the negative electrode current collector 1A to thereby from the base layer 1B.

Thereafter, the negative electrode active material including the silicon-containing material, the negative electrode binder including the N-vinylacetamide polymer, and the negative electrode conductor are mixed with each other to thereby obtain a negative electrode mixture. Thereafter, the negative electrode mixture is put into a solvent to thereby prepare a negative electrode mixture slurry in paste form. The solvent may be an aqueous solvent, or may be an organic solvent. Thereafter, the negative electrode mixture slurry is applied on a surface of the base layer 1B to thereby form the negative electrode active material layer 1C.

Lastly, the negative electrode active material layer 1C is compression-molded by, for example, a roll pressing machine. In this case, the negative electrode active material layer 1C may be heated. The negative electrode active material layer 1C may be compression-molded multiple times.

The base layer 1B and the negative electrode active material layer 1C are thus formed on the negative electrode current collector 1A. As a result, the negative electrode 1 is completed.

According to the negative electrode 1, the negative electrode 1 includes the negative electrode current collector 1A, the base layer 1B, and the negative electrode active material layer 1C. The negative electrode current collector 1A includes the metal material. The base layer 1B is the carbon-containing layer, and therefore includes the carbon material. The negative electrode active material layer 1C includes the negative electrode active material (the silicon-containing material) and the negative electrode binder (the N-vinylacetamide polymer).

In this case, the following series of kinds of action is achieved, as described above.

Firstly, because the negative electrode active material includes the silicon-containing material, a high energy density is obtainable in the negative electrode 1.

Secondly, because the base layer 1B (the carbon-containing layer) is interposed between the negative electrode current collector 1A and the negative electrode active material layer 1C, the interface resistance at the interface between the negative electrode current collector 1A and the negative electrode active material layer 1C decreases, and the adherence of the negative electrode active material layer 1C to the negative electrode current collector 1A improves. This improves the electrical conductivity between the negative electrode current collector 1A and the negative electrode active material layer 1C, and prevents the negative electrode active material layer 1C from being easily detached from the negative electrode current collector 1A. As a result, the electrical conductivity of the negative electrode 1 stably improves.

Thirdly, because the negative electrode binder includes the N-vinylacetamide polymer, the physical strength of the negative electrode active material layer 1C improves. Even upon repeated electrode reactions, this prevents the negative electrode active material layer 1C from being easily damaged and also prevents the negative electrode active material layer 1C from being easily detached from the negative electrode current collector 1A. As a result, the physical durability of the negative electrode 1 improves. In this case, in particular, even if the negative electrode active material includes the silicon-containing material that easily expands and contracts upon the electrode reaction, the physical durability of the negative electrode 1 effectively improves.

Based upon the foregoing, the negative electrode 1 improves in electrical conductivity and physical durability while securing the energy density. It is therefore possible to achieve a secondary battery having a superior battery characteristic by including the negative electrode 1.

Here, the negative electrode 1 includes the negative electrode current collector 1A together with the base layer 1B and the negative electrode active material layer 1C, and the base layer 1B is provided on the negative electrode current collector 1A, as described above. The use of the base layer 1B makes it possible to sufficiently improve the electrical conductivity between the negative electrode current collector 1A and the negative electrode active material layer 1C.

Further, the base layer 1B may include the base binder, and the base binder may include the N-vinylacetamide polymer. This improves the adherence between the base layer 1B (the carbon binder) and the negative electrode active material layer 1C (the negative electrode binder). Accordingly, it is possible to achieve higher effects.

Further, the negative electrode binder may further include either polyvinylidene difluoride or the styrene butadiene rubber. This further improves the physical strength of the negative electrode active material layer 1C. Thus, the negative electrode active material layer 1C is further prevented from being easily damaged even upon repeated electrode reactions. Accordingly, it is possible to achieve higher effects.

Further, the negative electrode active material may further include the carbon material. This suppresses the damage to the negative electrode active material layer 1C while the battery capacity is secured in the secondary battery including the negative electrode 1. Accordingly, it is possible to achieve higher effects.

A description is given next of a negative electrode for a secondary battery according to a second embodiment of the present technology. The negative electrode for the secondary battery will hereinafter be simply referred to as the “negative electrode”.

FIG. 2 illustrates a sectional configuration of a negative electrode 2 that is an example of the negative electrode of the second embodiment. FIG. 2 corresponds to FIG. 1. The negative electrode 2 has a configuration similar to the configuration of the negative electrode 1 except for including a negative electrode current collector 1D instead of the negative electrode current collector 1A and the base layer 1B, as illustrated in FIG. 2.

The negative electrode current collector 1D has a configuration similar to the configuration of the negative electrode current collector 1A except for the following points.

The negative electrode current collector 1D is a carbon-containing layer of the second embodiment. Accordingly, the negative electrode active material layer 1C is provided on the negative electrode current collector 1D, and the negative electrode current collector 1D is therefore adjacent to the negative electrode active material layer 1C. A thickness of the negative electrode current collector 1D is not particularly limited, and may be set as desired.

The negative electrode current collector 1D has two opposed surfaces on each of which the negative electrode active material layer 1C is to be provided. Here, the negative electrode active material layer 1C is provided on one of the two opposed surfaces of the negative electrode current collector 1D. Note, however, that the negative electrode active material layer 1C may be provided on each of the two opposed surfaces of the negative electrode current collector 1D.

The negative electrode current collector 1D is the carbon-containing layer as described above, and therefore includes any one or more of carbon materials. Details of the carbon material are as described above. Specifically, the negative electrode current collector 1D includes a sheet-shaped carbon material that is what is called a carbon sheet. Specific examples of the carbon sheet include a graphite sheet.

One reason why the negative electrode 2 includes the negative electrode current collector 1D is that an interface resistance at an interface between the negative electrode current collector 1D and the negative electrode active material layer 1C decreases, and adherence of the negative electrode active material layer 1C to the negative electrode current collector 1D improves. This improves electrical conductivity between the negative electrode current collector 1D and the negative electrode active material layer 1C, and prevents the negative electrode active material layer 1C from being easily detached from the negative electrode current collector 1D. As a result, electrical conductivity of the negative electrode 2 stably improves.

In particular, when the negative electrode current collector 1D that is the carbon sheet is used, a series of advantages below is obtainable, as compared with when the negative electrode current collector 1A including the metal material is used.

Firstly, a weight of the negative electrode current collector 1D (the carbon sheet) is smaller than a weight of the negative electrode current collector 1A (the metal material), which allows a weight of the negative electrode 2 to be smaller than a weight of the negative electrode 1. This increases an energy density (Wh/kg) per unit weight in the negative electrode 2 to higher than an energy density per unit weight in the negative electrode 1.

Secondly, the negative electrode current collector 1D (the carbon sheet) is prevented from being easily deformed, more specifically, being easily warped upon an electrode reaction, as compared with the negative electrode current collector 1A (the metal material). This makes it easier to stably maintain flatness of the negative electrode 2 than flatness of the negative electrode 1.

Thirdly, to secure a current collecting property of the negative electrode current collector 1D (the carbon sheet), the thickness of the negative electrode current collector 1D is set to be larger than a thickness of the negative electrode current collector 1A (the metal material). This improves heat dissipation of the negative electrode 2 more than heat dissipation of the negative electrode 1 even if the negative electrode 2 generates heat upon the electrode rection.

An operation of the negative electrode 2 is similar to the operation of the negative electrode 1. That is, upon the electrode reaction of the negative electrode 2, lithium is inserted into and extracted from the negative electrode active material included in the negative electrode active material layer 1C.

The negative electrode 2 is manufactured by the following example procedure.

First, the negative electrode current collector 1D that is the carbon sheet is prepared. Thereafter, the negative electrode mixture slurry is prepared by the procedure described in the first embodiment. Thereafter, the negative electrode mixture slurry is applied on one of the two opposed surfaces of the negative electrode current collector 1D to thereby from the negative electrode active material layer 1C. Lastly, the negative electrode active material layer 1C is compression-molded by the procedure described in the first embodiment.

The negative electrode active material layer 1C is thus formed on the negative electrode current collector 1D. As a result, the negative electrode 2 is completed.

According to the negative electrode 2, the negative electrode 2 includes the negative electrode current collector 1D and the negative electrode active material layer 1C. The negative electrode current collector 1D is the carbon-containing layer, and therefore includes the carbon material. The negative electrode active material layer 1C includes the negative electrode active material (the silicon-containing material) and the negative electrode binder (the N-vinylacetamide polymer).

In this case, the following series of kinds of action is achieved, as described above.

Firstly, because the negative electrode active material includes the silicon-containing material, a high energy density is obtainable in the negative electrode 2.

Secondly, the interface resistance at the interface between the negative electrode current collector 1D and the negative electrode active material layer 1C decreases, and the adherence of the negative electrode active material layer 1C to the negative electrode current collector 1D improves. This improves the electrical conductivity between the negative electrode current collector 1D and the negative electrode active material layer 1C, and prevents the negative electrode active material layer 1C from being easily detached from the negative electrode current collector 1D. As a result, the electrical conductivity of the negative electrode 2 improves stably.

Thirdly, because the negative electrode binder includes the N-vinylacetamide polymer, physical strength of the negative electrode current collector 1D is secured even if the negative electrode current collector 1D includes no metal material. Even upon repeated electrode reactions, this makes it easier for the negative electrode current collector 1D to stably support the negative electrode active material layer 1C, and prevents the negative electrode active material layer 1C from being easily detached from the negative electrode current collector 1D. As a result, physical durability of the negative electrode 2 improves. In this case, in particular, even if the negative electrode active material includes the silicon-containing material that easily expands and contracts upon the electrode reaction, the physical durability of the negative electrode 2 effectively improves.

Based upon the foregoing, the negative electrode 2 improves in electrical conductivity and physical durability while securing the energy density. It is therefore possible to achieve a secondary battery having a superior battery characteristic by including the negative electrode 2.

In this case, the negative electrode current collector 1D includes the carbon material, in particular. That is, the negative electrode current collector 1D includes the carbon sheet. This increases the energy density per unit weight in the negative electrode 2, makes it easier to stably maintain the flatness of the negative electrode 2, and improves the heat dissipation of the negative electrode 2, as described above. As a result, a secondary battery including the negative electrode 2 improves in battery characteristic more than the secondary battery including the negative electrode 1.

Other action and effects of the negative electrode 2 are similar to those of the negative electrode 1.

A description is given next of a secondary battery according to an embodiment of the present technology.

The secondary battery to be described here is a secondary battery in which a battery capacity is obtained through insertion and extraction of an electrode reactant, and includes a positive electrode, a negative electrode, and an electrolytic solution. Examples are given below of a case where the electrode reactant is lithium as in the description given above. A secondary battery in which the battery capacity is obtained through insertion and extraction of lithium is what is called a lithium-ion secondary battery. In the lithium-ion secondary battery, lithium is inserted and extracted in an ionic state.

A charge capacity of the negative electrode is preferably greater than a discharge capacity of the positive electrode. In other words, an electrochemical capacity per unit area of the negative electrode is preferably greater than an electrochemical capacity per unit area of the positive electrode. This is to suppress precipitation of lithium on a surface of the negative electrode during charging.

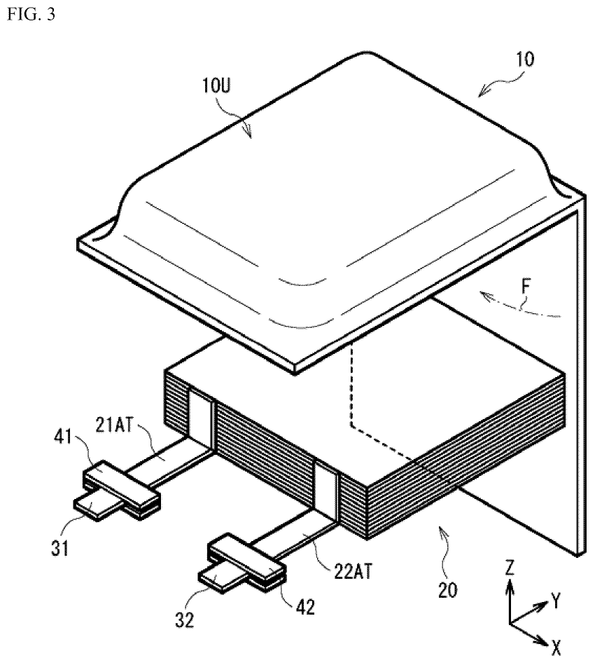

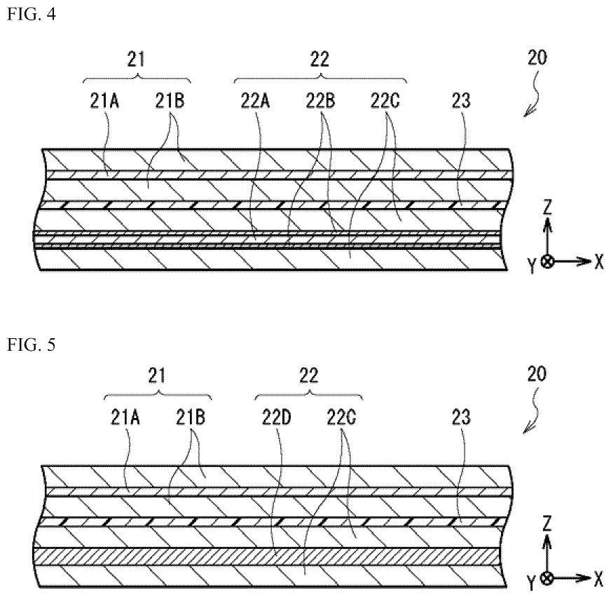

FIG. 3 illustrates a perspective configuration of the secondary battery. FIGS. 4 and 5 each illustrate, in an enlarged manner, a sectional configuration of a battery device 20 illustrated in FIG.

3. Note that FIG. 3 illustrates a state where an outer package film 10 and the battery device 20 are separated from each other, and illustrates a section of the battery device 20 along an XZ plane by a broken line. Further, FIGS. 4 and 5 each illustrate only a portion of the battery device 20.

The secondary battery includes the outer package film 10, the battery device 20, a positive electrode lead 31, a negative electrode lead 32, and sealing films 41 and 42, as illustrated in FIG. 3. The secondary battery described here is a secondary battery of a laminated-film type including the outer package film 10 that is flexible or soft.

The outer package film 10 is an outer package member to contain the battery device 20, as illustrated in FIG. 3, and has a pouch-shaped structure that is sealed in a state where the battery device 20 is contained in the outer package film 10. The outer package film 10 thus contains a positive electrode 21, a negative electrode 22, and an electrolytic solution that are to be described later.

Here, the outer package film 10 is a single film-shaped member and is folded toward a folding direction F. The outer package film 10 has a depression part 10U to place the battery device 20 therein. The depression part 10U is what is called a deep drawn part.

Specifically, the outer package film 10 is a three-layered laminated film including a fusion-bonding layer, a metal layer, and a surface protective layer stacked in this order from an inner side. In a state where the outer package film 10 is folded, outer edge parts of the fusion-bonding layer opposed to each other are fusion-bonded to each other. The fusion-bonding layer includes a polymer compound such as polypropylene. The metal layer includes a metal material such as aluminum. The surface protective layer includes a polymer compound such as nylon.

Note that the outer package film 10 is not particularly limited in configuration or the number of layers, and may be single-layered or two-layered, or may include four or more layers.

As illustrated in FIGS. 3 to 5, the battery device 20 is a power generation device that includes the positive electrode 21, the negative electrode 22, a separator 23, and the electrolytic solution (not illustrated). The battery device 20 is contained in the outer package film 10.

The battery device 20 is what is called a stacked electrode body. Accordingly, the positive electrode 21 and the negative electrode 22 are stacked on each other with the separator 23 interposed therebetween. The respective numbers of the positive electrodes 21, the negative electrodes 22, and the separators 23 to be stacked are not particularly limited. Here, multiple positive electrodes 21 and multiple negative electrodes 22 are alternately stacked with the separators 33 each interposed between corresponding one of the positive electrodes 21 and corresponding one of the negative electrodes 22.

As illustrated in FIGS. 4 and 5, the positive electrode 21 includes a positive electrode current collector 21A and a positive electrode active material layer 21B.

The positive electrode current collector 21A has two opposed surfaces on each of which the positive electrode active material layer 21B is to be provided. The positive electrode current collector 21A includes an electrically conductive material such as a metal material. Specific examples of the metal material include aluminum.

Note that as illustrated in FIG. 3, the positive electrode current collector 21A includes a protruding part 21AT without the positive electrode active material layer 21B provided thereon. Multiple protruding parts 21AT are joined to each other into a single lead form. Here, the protruding part 21AT is integrated with a portion of the positive electrode current collector 21A other than the protruding part 21AT. However, the protruding part 21AT may be provided separately from the portion of the positive electrode current collector 21A other than the protruding part 21AT, and may thus be joined to the portion of the positive electrode current collector 21A other than the protruding part 21AT.

Here, the positive electrode active material layer 21B is provided on each of the two opposed surfaces of the positive electrode current collector 21A. The positive electrode active material layer 21B includes any one or more of positive electrode active materials into which lithium is to be inserted and from which lithium is to be extracted. Note that the positive electrode active material layer 21B may be provided only on one of the two opposed surfaces of the positive electrode current collector 21A on a side where the positive electrode 21 is opposed to the negative electrode 22. In addition, the positive electrode active material layer 21B may further include any one or more of other materials including, without limitation, a positive electrode binder and a positive electrode conductor. A method of forming the positive electrode active material layer 21B is not particularly limited, and specifically includes any one or more of methods including, without limitation, the coating method.

The positive electrode active material is not particularly limited in kind, and specific examples thereof include a lithium-containing compound. The lithium-containing compound is a compound that includes lithium and one or more transition metal elements as constituent elements. The lithium-containing compound may further include one or more other elements as one or more constituent elements. The one or more other elements are not particularly limited in kind as long as the one or more other elements are each an element other than lithium and the transition metal elements. Specifically, the one or more other elements are any one or more of elements belonging to groups 2 to 15 in the long period periodic table. The lithium-containing compound is not particularly limited in kind, and is specifically an oxide, a phosphoric acid compound, a silicic acid compound, or a boric acid compound, for example.

Specific examples of the oxide include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, Li_{1.15}(Mn_{0.65}Ni_{0.22}Co_{0.13})O₂, and LiMn₂O₄. Specific examples of the phosphoric acid compound include LiFePO₄, LiMnPO₄, LiFe_{0.5}Mn_{0.5}PO₄, and LiFe_{0.3}Mn_{0.7}PO₄.

The positive electrode binder includes any one or more of materials including, without limitation, a synthetic rubber and a polymer compound. Specific examples of the synthetic rubber include a styrene-butadiene-based rubber, a fluorine-based rubber, and ethylene propylene diene. Specific examples of the polymer compound include polyvinylidene difluoride, polyimide, and carboxymethyl cellulose.

The positive electrode conductor includes any one or more of electrically conductive materials including, without limitation, a carbon material, a metal material, and an electrically conductive polymer compound. Specific examples of the carbon material include graphite, carbon black, acetylene black, and Ketjen black.

The negative electrode 22 may have a configuration similar to the configuration of the negative electrode 1 described above, or may have a configuration similar to the configuration of the negative electrode 2 described above.

Specifically, the negative electrode 22 may include a negative electrode current collector 22A, a base layer 22B, and a negative electrode active material layer 22C, as illustrated in FIG. 4. Configurations of the negative electrode current collector 22A, the base layer 22B, and the negative electrode active material layer 22C are respectively similar to the configurations of the negative electrode current collector 1A, the base layer 1B, and the negative electrode active material layer 1C.

In this case, the negative electrode current collector 22A includes a protruding part 22AT without the base layer 22B and the negative electrode active material layer 22C provided thereon, as illustrated in FIG. 3. Multiple protruding parts 22AT are joined to each other into a single lead form to thereby form a joined body. Here, the protruding part 22AT is integrated with a portion of the negative electrode current collector 22A other than the protruding part 22AT. However, the protruding part 22AT may be provided separately from the portion of the negative electrode current collector 22A other than the protruding part 22AT, and may thus be joined to the portion of the negative electrode current collector 22A other than the protruding part 22AT.

Alternatively, the negative electrode 22 may include a negative electrode current collector 22D and the negative electrode active material layer 22C, as illustrated in FIG. 5. Configurations of the negative electrode current collector 22D and the negative electrode active material layer 22C are respectively similar to the configurations of the negative electrode current collector 1D and the negative electrode active material layer 1C.

In this case, the negative electrode current collector 22D includes the protruding part 22AT without the negative electrode active material layer 22C provided thereon, as illustrated in FIG. 3. The multiple protruding parts 22AT are joined to each other into a single lead form to thereby form a joined body. The protruding part 22AT may be integrated with a portion of the negative electrode current collector 22D other than the protruding part 22AT, or may be provided separately from the portion of the negative electrode current collector 22D other than the protruding part 22AT, as described above.

As illustrated in FIGS. 4 and 5, the separator 23 is an insulating porous film interposed between the positive electrode 21 and the negative electrode 22, and allows a lithium ion to pass therethrough while preventing contact (a short circuit) between the positive electrode 21 and the negative electrode 22. The separator 23 includes a polymer compound such as polyethylene.

The electrolytic solution is a liquid electrolyte. The positive electrode 21, the negative electrode 22, and the separator 23 are each impregnated with the electrolytic solution. The electrolytic solution includes a solvent and an electrolyte salt.

Here, the solvent includes any one or more of non-aqueous solvents (organic solvents). The electrolytic solution including the one or more non-aqueous solvents is what is called a non-aqueous electrolytic solution. The non-aqueous solvent includes, for example, an ester or an ether, more specifically, any one or more of a carbonic-acid-ester-based compound, a carboxylic-acid-ester-based compound, or a lactone-based compound. One reason for this is that this improves a dissociation property of the electrolyte salt and ion mobility.

The carbonic-acid-ester-based compound is a cyclic carbonic acid ester or a chain carbonic acid ester. Specific examples of the cyclic carbonic acid ester include ethylene carbonate and propylene carbonate. Specific examples of the chain carbonic acid ester include dimethyl carbonate, diethyl carbonate, and ethyl methyl carbonate.

The carboxylic-acid-ester-based compound is, for example, a chain carboxylic acid ester. Specific examples of the chain carboxylic acid ester include ethyl acetate, ethyl propionate, propyl propionate, and ethyl trimethylacetate. The lactone-based compound is, for example, a lactone. Specific examples of the lactone include γ-butyrolactone and γ-valerolactone. Note that the ether may be, for example, 1,2-dimethoxy ethane, tetrahydrofuran, 1,3-dioxolane, or 1,4-dioxane.

The electrolyte salt includes any one or more of light metal salts including, without limitation, a lithium salt. Specific examples of the lithium salt include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl)methide (LiC(CF₃SO₂)₃), lithium bis(oxalato)borate (LiB(C₂O₄)₂), lithium monofluorophosphate (Li₂PFO₃), and lithium difluorophosphate (LiPF₂O₂). One reason for this is that a high battery capacity is obtainable.

A content of the electrolyte salt is not particularly limited, and is specifically within a range from 0.3 mol/kg to 3.0 mol/kg both inclusive with respect to the solvent. One reason for this is that high ion conductivity is obtainable.

Note that the electrolytic solution may further include any one or more of additives. One reason for this is that this improves electrochemical stability of the electrolytic solution. The additives are not particularly limited in kind, and specific examples thereof include an unsaturated cyclic carbonic acid ester, a fluorinated cyclic carbonic acid ester, a sulfonic acid ester, a phosphoric acid ester, an acid anhydride, a nitrile compound, and an isocyanate compound.

Specific examples of the unsaturated cyclic carbonic acid ester include vinylene carbonate, vinyl ethylene carbonate, and methylene ethylene carbonate. Specific examples of the fluorinated cyclic carbonic acid ester include monofluoroethylene carbonate and difluoroethylene carbonate. Specific examples of the sulfonic acid ester include propane sultone and propene sultone. Specific examples of the phosphoric acid ester include trimethyl phosphate and triethyl phosphate. Specific examples of the acid anhydride include succinic anhydride, 1,2-ethanedisulfonic anhydride, and 2-sulfobenzoic anhydride. Specific examples of the nitrile compound include succinonitrile. Specific examples of the isocyanate compound include hexamethylene diisocyanate.

As illustrated in FIGS. 3 to 5, the positive electrode lead 31 is a positive electrode terminal coupled to the joined body of the multiple protruding parts 21AT of the positive electrode 21, and is led to an outside of the outer package film 10. The positive electrode lead 31 includes an electrically conductive material such as a metal material. Specific examples of the metal material include aluminum. The positive electrode lead 31 is not particularly limited in shape, and specifically has any one of shapes including, without limitation, a thin plate shape and a meshed shape.

As illustrated in FIGS. 3 to 5, the negative electrode lead 32 is a negative electrode terminal coupled to the joined body of the multiple protruding parts 22AT of the negative electrode 22, and is led to the outside of the outer package film 10. The negative electrode lead 32 includes an electrically conductive material such as a metal material. Specific examples of the metal material include copper. Here, details of a direction in which the negative electrode lead 32 is led, and a shape of the negative electrode lead 32 are similar to those of the direction in which the positive electrode lead 31 is led, and the shape of the positive electrode lead 31.

As illustrated in FIG. 3, the sealing film 41 is interposed between the outer package film 10 and the positive electrode lead 31, and the sealing film 42 is interposed between the outer package film 10 and the negative electrode lead 32. Note that the sealing film 41, the sealing film 42, or both may be omitted.

The sealing film 41 is a sealing member that prevents entry of, for example, outside air into the outer package film 10, as illustrated in FIG. 3. The sealing film 41 includes a polymer compound such as a polyolefin that has adherence to the positive electrode lead 31. Specific examples of the polyolefin include polypropylene.

A configuration of the sealing film 42 is similar to that of the sealing film 41 except that the sealing film 42 is a sealing member that has adherence to the negative electrode lead 32. That is, the sealing film 42 includes a polymer compound such as a polyolefin that has adherence to the negative electrode lead 32.

The secondary battery operates as below upon charging and discharging.

Upon charging, in the battery device 20, lithium is extracted from the positive electrode 21, and the extracted lithium is inserted into the negative electrode 22 via the electrolytic solution. Upon discharging, in the battery device 20, lithium is extracted from the negative electrode 22, and the extracted lithium is inserted into the positive electrode 21 via the electrolytic solution. Upon each of the charging and the discharging, lithium is inserted and extracted in an ionic state.

To manufacture the secondary battery, the positive electrode 21 and the negative electrode 22 are each fabricated and the electrolytic solution is prepared, following which the secondary battery is assembled using the positive electrode 21, the negative electrode 22, and the electrolytic solution, and the assembled secondary battery is subjected to a stabilization process, in accordance with an example procedure described below.

First, a mixture (a positive electrode mixture) in which the positive electrode active material, the positive electrode binder, and the positive electrode conductor are mixed with each other is put into a solvent to thereby prepare a positive electrode mixture slurry in paste form. The solvent may be an aqueous solvent, or may be an organic solvent. Thereafter, the positive electrode mixture slurry is applied on the two opposed surfaces of the positive electrode current collector 21A including the protruding parts 21AT (but is not applied on the protruding parts 21AT) to thereby form the positive electrode active material layers 21B. Lastly, the positive electrode active material layers 21B may be compression-molded by, for example, a roll pressing machine. In this case, the positive electrode active material layer 21B may be heated. The positive electrode active material layer 21B may be compression-molded multiple times. The positive electrode active material layers 21B are thus formed on the two respective opposed surfaces of the positive electrode current collector 21A. As a result, the positive electrode 21 is fabricated.

The negative electrode 22 is fabricated by forming the base layers 22B and the negative electrode active material layers 22C on the two respective opposed surfaces of the negative electrode current collector 22A including the protruding parts 22AT (but not on the protruding parts 22AT) by a procedure similar to the fabrication procedure of the negative electrode 1 described above.

Alternatively, the negative electrode 22 is fabricated by forming the negative electrode active material layers 22C on the two respective opposed surfaces of the negative electrode current collector 22D by a procedure similar to the fabrication procedure of the negative electrode 2 described above.

The electrolyte salt is put into the solvent. The electrolyte salt is thereby dispersed or dissolved in the solvent. As a result, the electrolytic solution is prepared.

First, the positive electrodes 21 and the negative electrodes 22 are alternately stacked with the separators 23 each interposed between corresponding one of the positive electrodes 21 and corresponding one of the negative electrodes 22 to thereby fabricate an unillustrated stacked body.

Thereafter, the multiple protruding parts 21AT are joined to each other by a joining method such as a welding method to thereby form a joined body, and the multiple protruding parts 22AT are joined to each other by the joining method such as the welding method to thereby form a joined body. Thereafter, the positive electrode lead 31 is joined to the joined body of the multiple protruding parts 21AT by the joining method such as the welding method, and the negative electrode lead 32 is joined to the joined body of the multiple protruding parts 22AT by the joining method such as the welding method.

Thereafter, the wound body is placed inside the depression part 10U, following which the outer package film 10 (the fusion-bonding layer/the metal layer/the surface protective layer) is folded to thereby cause portions of the outer package film 10 to be opposed to each other. Thereafter, outer edge parts of two sides of the fusion-bonding layer opposed to each other are bonded to each other by a bonding method such as a thermal-fusion-bonding method to thereby allow the wound body to be contained inside the outer package film 10 having a pouch shape.

Lastly, the electrolytic solution is injected into the outer package film 10 having the pouch shape, following which outer edge parts of the remaining one side of the fusion-bonding layer opposed to each other are bonded to each other by the bonding method such as the thermal-fusion-bonding method. In this case, the sealing film 41 is interposed between the outer package film 10 and the positive electrode lead 31, and the sealing film 42 is interposed between the outer package film 10 and the negative electrode lead 32.

The wound body is thereby impregnated with the electrolytic solution. Thus, the battery device 20 that is a wound electrode body is formed. The battery device 20 is thus sealed in the outer package film 10 having the pouch shape. As a result, the secondary battery is assembled.

The assembled secondary battery is charged and discharged. Various conditions including, for example, an environment temperature, the number of times of charging and discharging (the number of cycles), and charging and discharging conditions, may be set as desired. As a result, a film is formed on the surface of each of the positive electrode 21 and the negative electrode 22, which electrochemically stabilizes a state of the battery device 20. The secondary battery is thus completed.

According to the secondary battery, the secondary battery includes the negative electrode 22, and the negative electrode 22 has a configuration similar to the configuration of the negative electrode 1 or the configuration of the negative electrode 2. Accordingly, the negative electrode 22 improves in electrical conductivity and physical durability while securing the energy density, for the reason described above. It is therefore possible to achieve a superior battery characteristic.

In particular, the secondary battery may include a lithium-ion secondary battery. This makes it possible to obtain a sufficient battery capacity stably through insertion and extraction of lithium. Accordingly, it is possible to achieve higher effects.

Other action and effects of the secondary battery are similar to those of the negative electrode 1 or the negative electrode 2.

A description is given next of modification examples according to an embodiment.

The configuration of each of the negative electrode for the secondary battery and the secondary battery described above is appropriately modifiable as described below. Note that any two or more of the following series of modification examples may be combined with each other.

In FIG. 1, the negative electrode 1 includes the base layer 1B. In contrast, in FIG. 2, the negative electrode 2 does not include the base layer 1B.

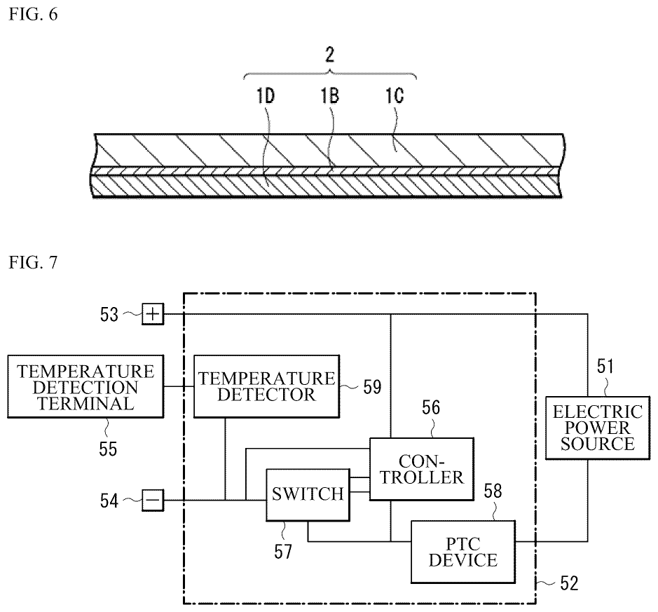

However, as illustrated in FIG. 6 corresponding to FIG. 2, the negative electrode 2 may further include the base layer 1B. The negative electrode 2 thus includes the negative electrode current collector 1D, the base layer 1B, and the negative electrode active material layer 1C. The negative electrode current collector 1D and the base layer 1B are each a carbon-containing layer of Modification example 1.

The negative electrode 2 illustrated in FIG. 6 has a configuration similar to the configuration of the negative electrode 2 illustrated in FIG. 2, except that the base layer 1B is interposed between the negative electrode current collector 1D and the negative electrode active material layer 1C. Note that the configuration of the base layer 1B is as described above.

In this case, the interface resistance at the interface between the negative electrode current collector 1D and the negative electrode active material layer 1C is markedly decreased by the use of the base layer 1B, which markedly improves the electrical conductivity between the negative electrode current collector 1D and the negative electrode active material layer 1C. As a result, the electrical conductivity of the negative electrode 2 improves markedly. Accordingly, it is possible to achieve higher effects.

In FIG. 3, the secondary battery includes the battery device 20 that is a stacked electrode body. However, although not specifically illustrated here, the secondary battery may include a battery device that is a wound electrode body.

In the battery device that is the wound electrode body, the positive electrode 21 and the negative electrode 22 are wound about a winding axis, being opposed to each other with the separator 23 interposed therebetween. The winding axis is a virtual axis.

The battery device is not particularly limited in three-dimensional shape. For example, the battery device has an elongated shape. Accordingly, a section of the battery device intersecting the winding axis has an elongated shape defined by a major axis and a minor axis. In this case, the battery device has an elongated cylindrical three-dimensional shape. Thus, the section of the battery device has an elongated, substantially elliptical shape.

To fabricate the battery device in a process of manufacturing the secondary battery, the positive electrode 21 and the negative electrode 22 are stacked on each other with the separator 23 interposed therebetween, following which the stack of the positive electrode 21, the negative electrode 22, and the separator 23 is wound to thereby fabricate a wound body (not illustrated). Thereafter, the wound body is pressed by, for example, a pressing machine to thereby shape the wound body into an elongated shape. The shaped wound body has a configuration similar to that of the battery device except that the positive electrode 21, the negative electrode 22, and the separator 23 are each not impregnated with the electrolytic solution.

When the battery device that is the wound electrode body is used also, the battery capacity is obtainable through insertion and extraction of lithium, and similar effects are therefore achievable.

The separator 23 that is a porous film is used. However, although not specifically illustrated here, a separator of a stacked type including a polymer compound layer may be used.

Specifically, the separator of the stacked type includes a porous film having two opposed surfaces, and the polymer compound layer provided on one of or each of the two opposed surfaces of the porous film. One reason for this is that adherence of the separator to each of the positive electrode 21 and the negative electrode 22 improves to suppress winding displacement of the battery device 20. This suppresses swelling of the secondary battery even if a decomposition reaction of the electrolytic solution occurs. The polymer compound layer includes a polymer compound such as polyvinylidene difluoride. One reason for this is that polyvinylidene difluoride is superior in physical strength and is electrochemically stable.

Note that the porous film, the polymer compound layer, or both may include multiple insulating particles. One reason for this is that the insulating particles promote heat dissipation upon heat generation by the secondary battery, thus improving safety or heat resistance of the secondary battery. The insulating particles include any one or more of insulating materials including, without limitation, inorganic materials and resin materials. Specific examples of the inorganic materials include aluminum oxide, aluminum nitride, boehmite, silicon oxide, titanium oxide, magnesium oxide, and zirconium oxide. Specific examples of the resin materials include acrylic resin and styrene resin.

To fabricate the separator of the stacked type, a precursor solution including the polymer compound and a solvent is prepared, following which the precursor solution is applied on one of or each of the two opposed surfaces of the porous film. In this case, instead of applying the precursor solution on the porous film, the porous film may be immersed in the precursor solution. Further, the insulating particles may be added to the precursor solution.

When the separator of the stacked type is used also, lithium is movable between the positive electrode 21 and the negative electrode 22, and similar effects are therefore achievable. In this case, in particular, the secondary battery improves in safety, as described above. Accordingly, it is possible to achieve higher effects.

The electrolytic solution, which is a liquid electrolyte, is used. However, although not specifically illustrated here, an electrolyte layer, which is a gel electrolyte, may be used.

In the battery device 20 including the electrolyte layer, the positive electrode 21 and the negative electrode 22 are stacked on each other with the separator 23 and the electrolyte layer interposed therebetween, and the stack of the positive electrode 21, the negative electrode 22, the separator 23, and the electrolyte layer is wound. The electrolyte layer is interposed between the positive electrode 21 and the separator 23, and between the negative electrode 22 and the separator 23. Note that the electrolyte layer may be interposed only between the positive electrode 21 and the separator 23, or may be interposed only between the negative electrode 22 and the separator 23.

The electrolyte layer includes a polymer compound together with the electrolytic solution. The electrolytic solution is held by the polymer compound. One reason for this is that leakage of the electrolytic solution is prevented. The configuration of the electrolytic solution is as described above. The polymer compound includes, for example, polyvinylidene difluoride. To form the electrolyte layer, a precursor solution including the electrolytic solution, the polymer compound, and a solvent is prepared, following which the precursor solution is applied on one side or both sides of the positive electrode 21 and on one side or both sides of the negative electrode 22.

When the electrolyte layer is used also, lithium is movable between the positive electrode 21 and the negative electrode 22 via the electrolyte layer, and similar effects are therefore achievable. In this case, in particular, the leakage of the electrolytic solution is prevented, as described above. Accordingly, it is possible to achieve higher effects.

Lastly, a description is given of applications (application examples) of the secondary battery according to an embodiment.

Applications of the secondary battery are not particularly limited. The secondary battery used as a power source may serve as a main power source or an auxiliary power source in, for example, electronic equipment and an electric vehicle. The main power source is preferentially used regardless of the presence of any other power source. The auxiliary power source may be used in place of the main power source, and may be switched from the main power source.

Specific examples of the applications of the secondary battery include: electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include battery systems for home use or industrial use in which electric power is accumulated for a situation such as emergency. In each of the above-described applications, one secondary battery may be used, or multiple secondary batteries may be used.

The battery packs may each include a battery cell, or may each include an assembled battery. The electric vehicle is a vehicle that travels with the secondary battery as a driving power source, and may be a hybrid automobile that is additionally provided with a driving source other than the secondary battery. In the electric power storage system for home use, electric power accumulated in the secondary battery that is an electric power storage source may be utilized for using, for example, home appliances.

An application example of the secondary battery will now be described in detail. The configuration of the application example described below is merely an example, and is appropriately modifiable.

FIG. 7 illustrates a block configuration of a battery pack. The battery pack described here is a battery pack (what is called a soft pack) including one secondary battery, and is to be mounted on, for example, electronic equipment typified by a smartphone.

As illustrated in FIG. 7, the battery pack includes an electric power source 51 and a circuit board 52. The circuit board 52 is coupled to the electric power source 51, and includes a positive electrode terminal 53, a negative electrode terminal 54, and a temperature detection terminal 55.

The electric power source 51 includes one secondary battery. The secondary battery has

a positive electrode lead coupled to the positive electrode terminal 53 and a negative electrode lead coupled to the negative electrode terminal 54. The electric power source 51 is couplable to outside via the positive electrode terminal 53 and the negative electrode terminal 54, and is thus chargeable and dischargeable. The circuit board 52 includes a controller 56, a switch 57, a PTC device 58 that is a thermosensitive resistive device, and a temperature detector 59. However, the PTC device 58 may be omitted.

The controller 56 includes, for example, a central processing unit (CPU) and a memory, and controls an operation of the battery pack. The controller 56 detects and controls a use state of the electric power source 51 on an as-needed basis.

If a voltage of the electric power source 51 (the secondary battery) reaches an overcharge detection voltage or an overdischarge detection voltage, the controller 56 turns off the switch 57. This prevents a charging current from flowing into a current path of the electric power source 51. The overcharge detection voltage is not particularly limited, and is specifically 4.20 V±0.05 V. The overdischarge detection voltage is not particularly limited, and is specifically 2.40 V±0.10 V.

The switch 57 includes, for example, a charge control switch, a discharge control switch, a charging diode, and a discharging diode. The switch 57 performs switching between coupling and decoupling between the electric power source 51 and external equipment in accordance with an instruction from the controller 56. The switch 57 includes, for example, a metal-oxide-semiconductor field-effect transistor (MOSFET). The charging and discharging currents are detected based on an ON-resistance of the switch 57.

The temperature detector 59 includes a temperature detection device such as a thermistor. The temperature detector 59 measures a temperature of the electric power source 51 through the temperature detection terminal 55, and outputs a result of the temperature measurement to the controller 56. The result of the temperature measurement to be obtained by the temperature detector 59 is used, for example, when the controller 56 performs charge and discharge control upon abnormal heat generation or when the controller 56 performs a correction process upon calculating a remaining capacity.

### EXAMPLES

A description is given of Examples of the present technology according to an embodiment.

### Examples 1 to 6 and Comparative Examples 1 to 7

First, secondary batteries each including the negative electrode 1 of the first embodiment were fabricated, following which the secondary batteries were each evaluated for a battery characteristic. Here, to evaluate the battery characteristic, two kinds of secondary batteries (a first secondary battery and a second secondary battery) were fabricated.

### Fabrication of First Secondary Battery

The first secondary battery (a lithium-ion secondary battery of a laminated-film type illustrated in FIGS. 3 and 4, having a battery capacity of 7 mAh to 12 mAh) was fabricated by the following procedure.

### Fabrication of Positive Electrode

First, 97 parts by mass of a positive electrode active material (LiNi_{0.8}Co_{0.15}Al_{0.05}O₂ as a lithium-containing compound (an oxide)), 2.2 parts by mass of a positive electrode binder (polyvinylidene difluoride), and 0.8 parts by mass of a positive electrode conductor (Ketjen black) were mixed with each other to thereby obtain a positive electrode mixture. Thereafter, the positive electrode mixture was put into a solvent (N-methyl-2-pyrrolidone as an organic solvent), following which the solvent was stirred to thereby prepare a positive electrode mixture slurry in paste form.

Thereafter, the positive electrode mixture slurry was applied on one of the two opposed surfaces of the positive electrode current collector 21A (a band-shaped aluminum foil having a thickness of 15 μm) including the protruding part 21AT (but was not applied on the protruding part 21AT) by a coating apparatus, following which the applied positive electrode mixture slurry was heated and dried (at a heating temperature of 120° C.) to thereby form the positive electrode active material layer 21B.

Lastly, the positive electrode active material layer 21B was compression-molded by a hand press machine, following which the positive electrode active material layer 21B was dried in a vacuum atmosphere. In this case, the positive electrode active material layers 21B was 3.5 g/cm³ in volume density. The positive electrode 21 was thus fabricated.

### Fabrication of Negative Electrode

First, 60 parts by mass of a carbon material (graphite, having a median diameter D50 of 0.5 μm) and 40 parts by mass of a base binder were mixed with each other to thereby obtain a base mixture. As the base binder, used were polyvinylidene difluoride (PVDF) and an N-vinylacetamide polymer (poly-N-vinylacetamide (PNVA) as a homopolymer of N-vinylacetamide). Thereafter, the base mixture was put into a solvent (pure water as an aqueous solvent), following which the solvent was kneaded and stirred by a planetary centrifugal mixer to thereby prepare a base mixture slurry in paste form.

Thereafter, the base mixture slurry was applied on one of the two opposed surfaces of the negative electrode current collector 22A including a metal material and including the protruding part 22AT (but was not applied on the protruding part 22AT), following which the base mixture slurry was dried to thereby form the base layer 22B (having a thickness of 0.2 μm to 0.4 μm). As the negative electrode current collector 22A, used were a copper foil (having a thickness of 6 μm), and stainless steel (SUS304, having a thickness of 6 μm).

Thereafter, 94.4 parts by mass of a negative electrode active material, 4 parts by mass of a negative electrode binder, and 1.6 parts by mass of a negative electrode conductor were mixed with each other to thereby obtain a negative electrode mixture.

As the negative electrode active material, used was a mixture of 66.1 parts by mass of predoped silicon oxide (having a median diameter D50 of 7 μm) as a silicon-containing material and 28.3 parts by mass of graphite (having a median diameter D50 of 21 μm) as a carbon material.

As the negative electrode binder, used were an N-vinylacetamide polymer (poly-N-vinylacetamide (PNVA)), a mixture (PNVA+PVDF) of poly-N-vinylacetamide and polyvinylidene difluoride, and a mixture (PNVA+SBR) of poly-N-vinylacetamide and a styrene butadiene rubber. A mixture ratio (a weight ratio) between poly-N-vinylacetamide and polyvinylidene difluoride or between poly-N-vinylacetamide and the styrene butadiene rubber in the mixture was set to 3:1.

As the negative electrode conductor, used was a mixture of 1 part by mass of carbon black as a particulate carbon material and an aqueous dispersion liquid (at a solid content concentration of 0.6%) including carbon nanotubes as a fibrous carbon material. The aqueous dispersion liquid included 0.4 parts by mass of carbon nanotubes (having an average fiber diameter of 2 nm), and 0.6 parts by mass of carboxymethyl cellulose as a dispersant.

Thereafter, the negative electrode mixture was put into a solvent (pure water as an aqueous solvent), following which the solvent was kneaded and stirred by the planetary centrifugal mixer to thereby prepare a negative electrode mixture slurry in paste form. Thereafter, the negative electrode mixture slurry was applied on the surface of the base layer 22B by the coating apparatus, following which the applied negative electrode mixture slurry was dried to thereby form the negative electrode active material layer 22C.

Lastly, the negative electrode active material layer 22C was compression-molded by the hand press machine, following which the negative electrode active material layer 22C was dried in a vacuum atmosphere. In this case, the negative electrode active material layer 22C was 1.6 g/cm³ in volume density. The negative electrode 22 was thus fabricated.

Note that the negative electrode 22 for comparison was fabricated by a similar procedure except that the base layer 22B was not formed. Further, the negative electrode 22 for comparison was fabricated by a similar procedure except that polyvinylidene difluoride was used as the negative electrode binder. Further, the negative electrode 22 for comparison was fabricated by a similar procedure except that a mixture (SBR+CMC) of the styrene butadiene rubber and carboxymethyl cellulose was used as the negative electrode binder. A mixture ratio (a weight ratio) between the styrene butadiene rubber and carboxymethyl cellulose in the mixture was set to 50:50.

### Preparation of Electrolytic Solution

An electrolyte salt (lithium hexafluorophosphate (LiPF₆) as a lithium salt) was added to a solvent, following which the solvent to which the electrolyte salt was added was stirred. Used as the solvent was a mixture of ethylene carbonate as a cyclic carbonic acid ester, dimethyl carbonate as a chain carbonic acid ester, and monofluoroethylene carbonate as a fluorinated cyclic carbonic acid ester. In this case, a mixture ratio (a weight ratio) between ethylene carbonate, dimethyl carbonate, and monofluoroethylene carbonate in the solvent was set to 30:60:10. A content of the electrolyte salt was set to 1 mol/kg with respect to the solvent. The electrolytic solution was thus prepared.

### Assembly of First Secondary Battery

First, the positive electrode 21 including the protruding part 21AT and the negative electrode 22 including the protruding part 22AT were stacked on each other with the separator 23 (a fine porous polyethylene film, having a thickness of 20 μm) interposed therebetween to thereby fabricate a stacked body (the positive electrode 21/the separator 23/the negative electrode 22).

Thereafter, the outer package film 10 was folded in such a manner as to sandwich the stacked body placed in the depression part 10U. In this case, the protruding parts 21AT and 22AT were led to an outside of the outer package film 10. As the outer package film 10, an aluminum laminated film was used in which a fusion-bonding layer (a polypropylene film having a thickness of 30 μm), a metal layer (an aluminum foil having a thickness of 40 μm), and a surface protective layer (a nylon film having a thickness of 25 μm) were stacked in this order from an inner side. Thereafter, outer edge parts of two sides of the fusion-bonding layer were thermal-fusion-bonded to each other to thereby allow the stacked body to be contained inside the outer package film 10 having the pouch shape.

Lastly, the electrolytic solution was injected into the outer package film 10 having the pouch shape and thereafter, outer edge parts of the remaining one side of the fusion-bonding layer were thermal-fusion-bonded to each other in a reduced-pressure environment. In this case, the sealing film 41 (a polypropylene film having a thickness of 5 μm) was interposed between the outer package film 10 and the protruding part 21AT, and the sealing film 42 (a polypropylene film having a thickness of 5 μm) was interposed between the outer package film 10 and the protruding part 22AT.

The stacked body was thereby impregnated with the electrolytic solution, and the battery device 20 was thus fabricated. Accordingly, the battery device 20 was sealed in the outer package film 10. As a result, the first secondary battery was assembled.

### Stabilization of First Secondary Battery

The first secondary battery was charged and discharged for one cycle in an ambient temperature environment (at a temperature of 23° C.). Upon charging, the first secondary battery was charged with a constant current of 0.1 C until a voltage reached 4.2 V, and was thereafter charged with a constant voltage of that value, 4.2 V, until a current reached 0.025 C. Upon discharging, the first secondary battery was discharged with a constant current of 0.1 C until the voltage reached 2.0 V. Note that 0.1 C was a value of a current that caused a battery capacity (a theoretical capacity) to be completely discharged in 10 hours, and 0.025° C. was a value of a current that caused the battery capacity to be completely discharged in 40 hours.

A film was thus formed on the surface of each of the positive electrode 21 and the negative electrode 22. This electrochemically stabilizes a state of the battery device 20. The first secondary battery (having a battery capacity of 10 mAh) was thus completed. When fabricating the first secondary battery, a thickness of the positive electrode active material layer 21B and the negative electrode active material layer 22C were adjusted to set a capacity ratio (=charge capacity of positive electrode 21/charge capacity of negative electrode 22), to 0.9.

### Fabrication of Second Secondary Battery

The second secondary battery (having a battery capacity of 10 mAh to 15 mAh) was fabricated by a procedure similar to the fabrication procedure of the first secondary battery described above, except that a lithium metal plate (having a thickness of 100 μm) was used instead of the positive electrode 21.

Here, the first secondary battery including the positive electrode 21 as a counter electrode to the negative electrode 22 was what is called a full cell, whereas the second secondary battery including the lithium metal plate as the counter electrode to the negative electrode 22 was what is called a half cell.

### Evaluation of Battery Characteristic

The secondary batteries were each evaluated for each of an electric resistance characteristic, an adherence characteristic, an initial charge and discharge characteristic, and a cyclability characteristic as the battery characteristic, which revealed the results presented in Table 1.

### Electric Resistance Characteristic

To evaluate the electric resistance characteristic, after the negative electrode 22 was fabricated and before the secondary battery was assembled using the negative electrode 22, electric resistance of the negative electrode 22 was measured using an electrode resistance meter (an electrode resistance system RM2611 available from HIOKI E.E. Corporation).

Specifically, an interface resistance of the negative electrode 22 as an index for evaluating the electric resistance characteristic was measured using the electrode resistance meter described above in an ambient temperature environment (at a temperature of 23° C.).

Note that values of the interface resistance listed in Table 1 are values normalized with respect to the value of the interface resistance of Comparative example 1 assumed to be 100.

### Adherence Characteristic

To evaluate the adherence characteristic, after the negative electrode 22 was fabricated and before the secondary battery was assembled using the negative electrode 22, a peel test was performed on the negative electrode 22 by a tensile tester.

Specifically, an adhesive tape (an adhesive tape G9000 available from Dexerials Corporation) was applied on a surface of the negative electrode active material layer 22C, following which the adhesive tape was pulled in a 180° direction to thereby peel the negative electrode active material layer 22C from the negative electrode current collector 22A. A peel strength of the negative electrode 22 as an index for evaluating the adherence characteristic was thus measured. When pulling the adhesive tape, a tensile rate of the adhesive tape was 10 cm/min. Further, when measuring the peel strength, an average value of the peel strengths measured after a fixed period from the start of pulling of the adhesive tape, i.e., when 10 seconds to 40 seconds passed after the start of the pulling.

Note that values of the peel strength listed in Table 1 are values normalized with respect to the value of the peel strength of Comparative example 1 assumed to be 100. Here, an allowable range of the peel strength was 20 or greater.

### Initial Charge and Discharge Characteristic

The initial charge and discharge characteristic was evaluated using the second secondary battery (the half cell).

Specifically, first, the second secondary battery was charged and discharged in an ambient temperature environment (at a temperature of 23° C.) to thereby measure a discharge capacity.

Upon the charging, the second secondary battery was charged with a constant current of 0.1 C until a voltage reached 0.005 V, and was thereafter charged with a constant voltage of that value, 0.005 V until a current reached 0.01 C. Upon the discharging, the second secondary battery was discharged with a constant current of 0.1 C until the voltage reached 1.5 V. Note that 0.01 C was a value of a current that caused the battery capacity to be completely discharged in 100 hours.

Thereafter, the second secondary battery having undergone the charging and the discharging was disassembled to thereby collect the negative electrode 22, following which a weight of the negative electrode 22 was measured. The weight of the negative electrode 22 was a sum of a weight of the negative electrode current collector 22A, a weight of the base layer 22B, and a weight of the negative electrode active material layer 22C.

Lastly, an initial capacity as an index for evaluating the initial charge and discharge characteristic was calculated based on the following calculation expression: initial capacity (mAh/g)=discharge capacity (mAh)/weight (g) of negative electrode 22.

Note that values of the initial capacity listed in Table 1 are values normalized with respect to the value of the initial capacity of Comparative example 1 assumed to be 100.

### Cyclability Characteristic

The cyclability characteristic was evaluated using the first secondary battery (the full cell).

Specifically, first, the first secondary battery was charged and discharged in an ambient temperature environment (at a temperature of 23° C.) to thereby measure the discharge capacity (a first-cycle discharge capacity). Thereafter, the first secondary battery was repeatedly charged and discharged in the same environment until the number of cycles reached 200 to thereby measure the discharge capacity (a 200th-cycle discharge capacity). Lastly, a capacity retention rate as an index for evaluating the cyclability characteristic was calculated based on the following calculation expression: capacity retention rate (%)=(200th-cycle discharge capacity/first-cycle discharge capacity)×100.

When charging and discharging the first secondary battery, the first secondary battery was charged and discharged while applying pressure to the first secondary battery by sandwiching the first secondary battery between two press plates from above and below. In this case, the pressure to be applied to the first secondary battery was set to 0.5 MPa.

Upon the charging, the first secondary battery was charged with a constant current of 0.5 C until a voltage reached 4.2 V, and was thereafter charged with a constant voltage of that value, 4.2 V, until a current reached 0.025 C. Upon the discharging, the first secondary battery was discharged with a constant current of 0.5 C until the voltage reached 2.5 V. Note that 0.5° C. was a value of a current that caused a battery capacity to be completely discharged in 2 hours.

Note that values of the capacity retention rate listed in Table 1 are values normalized with respect to the value of the capacity retention rate of Comparative example 1 assumed to be 100.

TABLE 1

| | Negative | | | Negative electrode | | | | | |
|---|---|---|---|---|---|---|---|---|---|
| | electrode | | | active material layer | | | | | |
| | current | | | Negative | | | | | |
| | collector | Base layer | | electrode | Negative | | | | Capacity |
| | (Metal | Carbon | Base | active | electrode | Interface | Peel | Initial | retention |
| | material) | material | binder | material | binder | resistance | strength | capacity | rate |
| Example 1 | Copper | Graphite | PVDF | Silicon | PNVA | 29 | 34 | 113 | 126 |
| | | | | oxide + | | | | | |
| | | | | graphite | | | | | |
| Example 2 | Copper | Graphite | PVDF | Silicon | PNVA + | 66 | 44 | 111 | 144 |
| | | | | oxide + | PVDF | | | | |
| | | | | graphite | | | | | |
| Example 3 | Copper | Graphite | PVDF | Silicon | PNVA + | 69 | 38 | 109 | 140 |
| | | | | oxide + | SBR | | | | |
| | | | | graphite | | | | | |
| Example 4 | Stainless | Graphite | PVDF | Silicon | PNVA | 64 | 29 | 106 | 116 |
| | steel | | | oxide + | | | | | |
| | | | | graphite | | | | | |
| Example 5 | Stainless | Graphite | PVDF | Silicon | PNVA + | 70 | 52 | 104 | 138 |
| | steel | | | oxide + | PVDF | | | | |
| | | | | graphite | | | | | |
| Example 6 | Copper | Graphite | PNVA | Silicon | PNVA | 85 | 58 | 113 | 164 |
| | | | | oxide + | | | | | |
| | | | | graphite | | | | | |
| Comparative | Copper | — | — | Silicon | PVDF | 100 | 100 | 100 | 100 |
| example 1 | | | | oxide + | | | | | |
| | | | | graphite | | | | | |
| Comparative | Stainless | — | — | Silicon | PVDF | 1320 | 108 | 96 | 110 |
| example 2 | steel | | | oxide + | | | | | |
| | | | | graphite | | | | | |
| Comparative | Copper | — | — | Silicon | SBR + | 142 | 9 | 94 | 36 |
| example 3 | | | | oxide + | CMC | | | | |
| | | | | graphite | | | | | |
| Comparative | Copper | Graphite | PVDF | Silicon | PVDF | 83 | 117 | 100 | 102 |
| example 4 | | | | oxide + | | | | | |
| | | | | graphite | | | | | |
| Comparative | Copper | Graphite | PVDF | Silicon | SBR + | 123 | 18 | 93 | 54 |
| example 5 | | | | oxide + | CMC | | | | |
| | | | | graphite | | | | | |
| Comparative | Copper | — | — | Silicon | PNVA | 73 | 88 | 110 | 107 |
| example 6 | | | | oxide + | | | | | |
| | | | | graphite | | | | | |
| Comparative | Stainless | — | — | Silicon | PNVA | 1069 | 28 | 95 | 109 |
| example 7 | steel | | | oxide + | | | | | |
| | | | | graphite | | | | | |

As indicated in Table 1, the interface resistance, the peel strength, the initial capacity, and the capacity retention rate each varied greatly depending on the configuration of the negative electrode 22.

In the following description, respective values of the interface resistance, the peel strength, the initial capacity, and the capacity retention rate in a case where the base layer 22B was not used and the negative electrode binder included no N-vinylacetamide polymer (Comparative example 1) are each taken as a comparative reference.

When the base layer 22B was not used and the negative electrode binder included no N-vinylacetamide polymer (Comparative examples 2 and 3), none of the interface resistance, the peel strength, the initial capacity, and the capacity retention rate sufficiently improved. In particular, in some cases, the interface resistance markedly increased, and each of the peel strength and the capacity retention rate markedly decreased.

In addition, also when the base layer 22B was used but the negative electrode binder included no N-vinylacetamide polymer (Comparative examples 4 and 5), none of the interface resistance, the peel strength, the initial capacity, and the capacity retention rate sufficiently improved similarly. In particular, in some cases, the interface resistance markedly increased, and each of the peel strength and the capacity retention rate markedly decreased.

Further, also when the base layer 22B was not used but the negative electrode binder included the N-vinylacetamide polymer (Comparative examples 6 and 7), none of the interface resistance, the peel strength, the initial capacity, and the capacity retention rate sufficiently improved similarly. In particular, in some cases, the interface resistance markedly increased.

In contrast, when the base layer 22B was used and the negative electrode binder included the N-vinylacetamide polymer (Examples 1 to 6), all of the interface resistance, the peel strength, the initial capacity, and the capacity retention rate sufficiently improved. More specifically, while the peel strength within the allowable range was secured, the interface resistance sufficiently decreased, and each of the initial capacity and the capacity retention rate sufficiently increased.

In particular, when the base layer 22B was used and the negative electrode binder included the N-vinylacetamide polymer, the following tendencies were obtained.

Firstly, while the peel strength within the allowable range was secured, the interface resistance sufficiently decreased and each of the initial capacity and the capacity retention rate sufficiently increased without depending on the kind of the negative electrode current collector (the metal material).

Secondly, when the negative electrode active material included both the silicon-containing material and the carbon material, each of the initial capacity and the capacity retention rate sufficiently increased.

Thirdly, when the negative electrode binder included the polyvinylidene difluoride or the styrene butadiene rubber together with the N-vinylacetamide polymer, the capacity retention rate further increased.

Fourthly, when the base binder included the N-vinylacetamide polymer, the capacity retention rate further increased.

### Examples 7 to 10 and Comparative Examples 8 and 9

Secondary batteries each including the negative electrode 2 of the second embodiment were fabricated, following which the secondary batteries were each evaluated for a battery characteristic. Here, to evaluate the battery characteristic, two kinds of secondary batteries were fabricated.

### Fabrication of First Secondary Battery

A fabrication procedure of the first secondary battery (a lithium-ion secondary battery of the laminated-film type illustrated in FIGS. 3 and 5) was similar to the fabrication procedure of the first secondary battery (the lithium-ion secondary battery of the laminated film type illustrated in FIGS. 3 and 4) described above, except that the fabrication procedure of the negative electrode 22 was different.

To fabricate the negative electrode 22, the negative electrode active material layer 22C was formed on each of the two opposed surfaces of the negative electrode current collector 22D (a carbon sheet having a thickness of 12 μm) including a carbon material (graphite). A graphite sheet was used as the carbon sheet.

In addition, Modification example 1 illustrated in FIG. 6 was adopted to fabricate the negative electrode 22. Thus, the negative electrode active material layer 22C was formed on each of the two opposed surfaces of the negative electrode current collector 22D with the base layer 22B interposed therebetween.

### Fabrication of Second Secondary Battery

A fabrication procedure of the second secondary battery was similar to the fabrication procedure of the first secondary battery described above, except that a lithium metal plate (having a thickness of 100 μm) was used instead of the positive electrode 21.

### Evaluation of Battery Characteristic

The secondary batteries were each evaluated for each of the electric resistance characteristic, the adherence characteristic, the initial charge and discharge characteristic, and the cyclability characteristic as the battery characteristic, which revealed the results presented in Table 2. Note that an evaluation procedure of each of the electric resistance characteristic, the adherence characteristic, the initial charge and discharge characteristic, and the cyclability characteristic was as described above.

Note that values of the interface resistance, the peel strength, the initial capacity, and the capacity retention rate listed in Table 2 are respectively values normalized with respect to the values of the interface resistance, the peel strength, the initial capacity, and the capacity retention rate of Comparative example 1 assumed to be 100.

TABLE 2

| | Negative | | | Negative electrode | | | | | |
|---|---|---|---|---|---|---|---|---|---|
| | electrode | | | active material layer | | | | | |
| | current | | | Negative | | | | | |
| | collector | Base layer | | electrode | Negative | | | | Capacity |
| | (Metal | Carbon | Base | active | electrode | Interface | Peel | Initial | retention |
| | material) | material | binder | material | binder | resistance | strength | capacity | rate |
| Example 7 | Graphite | — | — | Silicon | PNVA | 4 | 23 | 153 | 128 |
| | | | | oxide + | | | | | |
| | | | | graphite | | | | | |
| Example 8 | Graphite | — | — | Silicon | PNVA + | 5 | 45 | 149 | 143 |
| | | | | oxide + | PVDF | | | | |
| | | | | graphite | | | | | |
| Example 9 | Graphite | — | — | Silicon | PNVA + | 31 | 40 | 138 | 131 |
| | | | | oxide + | SBR | | | | |
| | | | | graphite | | | | | |
| Example 10 | Graphite | Graphite | PVDF | Silicon | PNVA | 23 | 34 | 154 | 152 |
| | | | | oxide + | | | | | |
| | | | | graphite | | | | | |
| Comparative | Copper | — | — | Silicon | PVDF | 100 | 100 | 100 | 100 |
| example 1 | | | | oxide + | | | | | |
| | | | | graphite | | | | | |
| Comparative | Graphite | — | — | Silicon | PVDF | 71 | 73 | 127 | 90 |
| example 8 | | | | oxide + | | | | | |
| | | | | graphite | | | | | |
| Comparative | Graphite | — | — | Silicon | SBR + | 89 | 7 | 115 | 62 |
| example 9 | | | | oxide + | CMC | | | | |
| | | | | graphite | | | | | |

As indicated in Table 2, the interface resistance, the peel strength, the initial capacity, and the capacity retention rate each varied greatly depending on the configuration of the negative electrode 22.

In the following description, the respective values of the interface resistance, the peel strength, the initial capacity, and the capacity retention rate in Comparative example 1 are each taken as a comparative reference.

When the negative electrode current collector 22D that was the carbon sheet was used but the negative electrode binder included no N-vinylacetamide polymer (Comparative examples 8 and 9), none of the interface resistance, the peel strength, the initial capacity, and the capacity retention rate sufficiently improved. In particular, in some cases, the peel strength markedly decreased, and the capacity retention rate markedly decreased.

In contrast, when the negative electrode current collector 22D that was the carbon sheet was used and the negative electrode binder included the N-vinylacetamide polymer (Examples 7 to 10), all of the interface resistance, the peel strength, the initial capacity, and the capacity retention rate sufficiently improved. More specifically, while the peel strength within the allowable range was secured, the interface resistance sufficiently decreased, and each of the initial capacity and the capacity retention rate sufficiently increased.

In particular, when the negative electrode current collector 22D that was the carbon sheet was used and the negative electrode binder included the N-vinylacetamide polymer, the following tendencies were obtained.

Firstly, when the negative electrode active material included both the silicon-containing material and the carbon material, each of the initial capacity and the capacity retention rate sufficiently increased.

Secondly, when the negative electrode binder included the polyvinylidene difluoride or the styrene butadiene rubber together with the N-vinylacetamide polymer, the capacity retention rate further increased.

Thirdly, when the negative electrode 22 further included the base layer 22B, each of the initial capacity and the capacity retention rate further increased.

Based upon the results presented in Tables 1 and 2, when the negative electrode 22 included the negative electrode current collector 22A (the metal material), the base layer 22B (the carbon material), and the negative electrode active material layer 22C and the negative electrode active material layer 22C included the negative electrode active material (the silicon-containing material) and the negative electrode binder (the N-vinylacetamide polymer), all of the electric resistance characteristic, the adherence characteristic, the initial charge and discharge characteristic, and the cyclability characteristic improved. Accordingly, it was possible to achieve a secondary battery having a superior battery characteristic.

A tendency to achieve the superior battery characteristic was similarly obtained also when the negative electrode 22 included the negative electrode current collector 22D (the carbon material) and the negative electrode active material layer 22C and the negative electrode active material layer 22C included the negative electrode active material (the silicon-containing material) and the negative electrode binder (the N-vinylacetamide polymer).

Although the present technology has been described above with reference to one or more embodiments including Examples, the configuration of the present technology is not limited thereto, and is therefore modifiable in a variety of ways.

Specifically, the description has been given of the case where the secondary battery has a battery structure of the laminated-film type or the coin type. However, the battery structure of the secondary battery is not particularly limited. The battery structure of the secondary battery may be, for example, of a cylindrical type, a prismatic type, or a button type.

Further, the description has been given of the case where the battery device has a device structure of a wound type. However, the device structure of the battery device is not particularly limited, and may be of any other type such as a stacked type or a zigzag folded type. In the stacked type, the positive electrode and the negative electrode are stacked on each other. In the zigzag folded type, the positive electrode and the negative electrode are folded in a zigzag manner.

Further, although the description has been given of the case where the electrode reactant is lithium, the electrode reactant is not particularly limited. Specifically, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present technology are therefore not limited to those described herein. Accordingly, the present technology may achieve any other effect.

Note that the present technology may have any of the following configurations according to an embodiment.

<1>

A secondary battery including:
a positive electrode;
a negative electrode; and
an electrolytic solution, in which
the negative electrode includes
   a carbon-containing layer, and
   a negative electrode active material layer provided on the carbon-containing layer, and
the negative electrode active material layer includes
   a negative electrode active material including a silicon-containing material, and
   a negative electrode binder including an N-vinylacetamide polymer.
      <2>

The secondary battery according to <1>, in which
the negative electrode further includes a negative electrode current collector including a metal material, and
the carbon-containing layer includes a base layer provided on the negative electrode current collector.
   <3>

The secondary battery according to <2>, in which
the carbon-containing layer further includes a carbon binder, and
the carbon binder includes an N-vinylacetamide polymer.
   <4>

The secondary battery according to <1>, in which
the negative electrode further includes a negative electrode current collector, and
the carbon-containing layer includes the negative electrode current collector.
   <5>

The secondary battery according to <1>, in which
the negative electrode further includes
   a negative electrode current collector, and
   a base layer provided on the negative electrode current collector, and
the carbon-containing layer includes the negative electrode current collector and the base layer.
   <6>

The secondary battery according to any one of <1>to <5>, in which the negative electrode binder further includes either polyvinylidene difluoride or a styrene butadiene rubber.

<7>

The secondary battery according to any one of <1>to <6>, in which the negative electrode active material further includes a carbon material.

<8>

The secondary battery according to any one of <1>to <7>, in which the secondary battery includes a lithium-ion secondary battery.

<9>

A negative electrode for a secondary battery, the negative electrode including:
a carbon-containing layer; and
a negative electrode active material layer provided on the carbon-containing layer, in which
the negative electrode active material layer includes
   a negative electrode active material including a silicon-containing material, and
   a negative electrode binder including an N-vinylacetamide polymer.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode;
a negative electrode; and
an electrolytic solution, wherein
the negative electrode includes
a carbon-containing layer, and
a negative electrode active material layer provided on the carbon-containing layer, and
the negative electrode active material layer includes
a negative electrode active material including a silicon-containing material, and
a negative electrode binder including an N-vinylacetamide polymer.

2. The secondary battery according to claim 1, wherein
the negative electrode further includes a negative electrode current collector including a metal material, and
the carbon-containing layer comprises a base layer provided on the negative electrode current collector.

3. The secondary battery according to claim 2, wherein
the carbon-containing layer further includes a carbon binder, and
the carbon binder includes an N-vinylacetamide polymer.

4. The secondary battery according to claim 1, wherein
the negative electrode further includes a negative electrode current collector, and
the carbon-containing layer comprises the negative electrode current collector.

5. The secondary battery according to claim 1, wherein
the negative electrode further includes
a negative electrode current collector, and
a base layer provided on the negative electrode current collector, and
the carbon-containing layer comprises the negative electrode current collector and the base layer.

6. The secondary battery according to claim 1, wherein the negative electrode binder further includes either polyvinylidene difluoride or a styrene butadiene rubber.

7. The secondary battery according to claim 1, wherein the negative electrode active material further includes a carbon material.

8. The secondary battery according to claim 1, wherein the secondary battery comprises a lithium-ion secondary battery.

9. A negative electrode for a secondary battery, the negative electrode comprising:
a carbon-containing layer; and
a negative electrode active material layer provided on the carbon-containing layer, wherein
the negative electrode active material layer includes
a negative electrode active material including a silicon-containing material, and
a negative electrode binder including an N-vinylacetamide polymer.
